(19) United States
(12) Patent Application Publication
(10) Pub. No.: US 2020/0157442 A1
(43) Pub. Date: May 21, 2020

(54) METHOD AND FACILITY FOR PRODUCING ELECTRICITY FROM AN SRF LOAD

(71) Applicant: CHO POWER, Morcenx (FR)

(72) Inventor: Yannick FERRIERE, Daignac (FR)

(21) Appl. No.: 16/604,247

(22) PCT Filed: Mar. 29, 2018
(86) PCT No.: PCT/FR2018/050789

§ 371 Date: Oct. 10, 2019

(30) Foreign Application Priority Data
Apr. 11, 2017 (FR) 1753173

(51) Int. Cl. C10J 3/84; C10K 3/00; F02C 3/28

(52) U.S. Cl. CPC C10J 3/84; C10K 3/008; F02C 3/28; C10J 2300/1675; C10J 2300/1861; C10J 2300/0946; C10J 2300/0956

(57) ABSTRACT

A method and a facility for producing electricity, wherein the following steps are performed: a) supplying a solid recovered fuel, b) producing a raw synthesis gas from the solid recovered fuel, c) purifying the raw synthesis gas in order to generate a synthesis gas in which the reduced concentration of tars determines a dew point of the tars less than or equal to 20° C., d) cleaning the synthesis gas purified in this way in order to obtain a clean synthetic gas, e) lowering the relative humidity of the clean synthesis gas, and f) injecting at least a portion thereof into a gas engine in order to produce electricity.

### CROSS REFERENCE TO RELATED APPLICATIONS

This application is a National Stage of International Application No. PCT/FR2018/050789, having an International Filing Date of 29 Mar. 2018, which designated the United States of America, and which International Application was published under PCT Article 21(2) as WO Publication No. 2018/189448 A1, which claims priority from and the benefit of French Patent Application No. 1753173, filed on 11 Apr. 2017, the disclosures of which are incorporated herein by reference in their entireties.

### BACKGROUND

### 1. Field

The presently disclosed embodiment, is in the general field of upgrading waste from renewable resources, notably from a solid recovered fuel (SRF) feedstock. The disclosed embodiment relates more precisely to a process for producing electrical energy from such an SRF feedstock.

The disclosed embodiment is also directed toward a facility for performing this process for producing electrical energy.

### 2. Brief Description of Related Developments

Nowadays, the diversification of energy resources is a real challenge for the majority of countries. With fossil resources diminishing, it becomes necessary for these countries to import fossil energy, which gives rise to substantial costs in their commercial balance.

Thus, the use of renewable endogenous energies constitutes a major environmental and economic challenge for these countries.

It is thus known practice to produce electrical energy from biomass. This biomass is first transformed into synthesis gas in a gasification reactor, this gas being cooled and cleaned and then injected into gas engines coupled to an electric generator to produce electrical energy.

However, it is observed that the prior art processes for producing electricity from renewable resources have many drawbacks.

Thus, although it is known that gas engines have a higher yield than steam turbines, they are not capable of instantaneously responding to large fluctuations in terms of quantity and quality of synthesis gas injected at their inlet.

Now, these prior art processes, on account notably of the nature of the feedstock to be treated, give rise to large variations in the quality of the synthesis gas produced, notably in terms of lower heating value (LHV).

Furthermore, deterioration of gas engines may be observed in the case of condensation of the water and pollutants such as tars contained in the synthesis gas produced, their deposition being liable to impair the correct functioning of certain constituent members of the engine and, consequently, of leading to stoppage of the engine.

Moreover, fuels prepared from ground non-fermentable household waste (HW) and ground ordinary industrial waste (OIW) are known, which are referred to as “solid recovered fuels” (SRF).

These fuels have the advantage of having a substantial lower heating value (LHV), but contain, for example, chlorine and sulfur. Hitherto, such fuels have essentially been used in cement works since the variable quality of the fuels (particle size, chlorine content, ash content, etc.) makes them difficult to use in other fields.

There is thus an urgent need for a novel process for producing electrical energy which makes it possible to overcome the prior art drawbacks presented above.

### SUMMARY

The presently disclosed embodiment is directed toward overcoming the prior art drawbacks by proposing a process for producing electrical energy from non-fermentable sorted endogenous waste, which is simple in its conception and in its implementation, reliable and economical, and which addresses the drawbacks mentioned above.

Notably, one subject of the presently disclosed embodiment is such a process for feeding gas engines with a clean synthesis gas having the required specificities: minimum content of pollutants, minimum amount of water, temperature less than or equal to a maximum service temperature, constant or substantially constant LHV, which is greater than or equal to a minimum threshold value.

Another subject of the presently disclosed embodiment is such a process which provides a constant flow rate and pressure of clean synthesis gas to the inlet of gas engines.

Yet another subject of the presently disclosed embodiment, is such a process which ensures overall energy (electrical and thermal) optimization thereof.

The presently disclosed embodiment is also directed toward an industrial facility such as a power station, for performing this process for producing electrical energy.

To this end, the disclosed embodiment relates to a process for producing electricity.

According to the disclosed embodiment, the following successive steps are performed:

a) providing a solid recovered fuel SRF,

b) producing a raw synthesis gas from the solid recovered fuel,

c) purifying said raw synthesis gas to generate a synthesis gas whose reduced concentration of tars determines a dew point of said tars of less than or equal to 20° C., said purification step comprising the injection of said raw synthesis gas into a mixing zone, in which said raw synthesis gas encounters and is mixed with at least one plasma jet and/or at least one oxidant stream, and initiation of a reaction between said synthesis gas and said at least one plasma jet and/or said at least one oxidant stream in a reaction zone placed downstream of said mixing zone to thermally crack the tars, the temperature of the synthesis gas at the outlet of said reaction zone being greater than or equal to 1100° C.,

d) cleaning said synthesis gas thus purified to obtain a clean synthesis gas,

e) lowering the relative degree of humidity of the clean synthesis gas,

f) injecting at least a portion thereof into at least one gas engine to produce electricity.

The solid recovered fuel (SRF) feedstock to be treated is thus free of fermentable matter and is in ground form.

In step c), the thermal cracking makes it possible to break the tar chains into smaller chains and also into carbon monoxide CO and dihydrogen H₂. Lowering of the dew point of the tars is thus obtained, which passes from about 170° C. before treatment to a temperature of the order of 20° C. In addition, the LHV of the synthesis gas thus purified is advantageously conserved.

For purely illustrative purposes, in step c), the oxidant stream is air or oxygen-enriched air.

Advantageously, the formation of condensates in the gas engine(s) is avoided by removing from the synthesis gas produced in step b) notably tars in step c), solid particles, bromine, fluorine and chlorine in step d) and water in step e).

The clean synthesis gas thus obtained via the process of the disclosed embodiment, then permits safe feeding of the gas engine(s), preventing any possible degradation thereof. The physical integrity and the yield of the gas engines are thus preserved.

In various particular embodiments of this process for producing electricity, each having its particular advantages and being susceptible to numerous possible technical combinations:

after step c) and before step d), the purified synthesis gas is cooled in a water-fed heat-recovery boiler which performs the heating of said water by recovering the heat from said synthesis gas to produce steam and to feed with said steam at least one steam turbine,

in step e), the clean synthesis gas is cooled to a temperature below a temperature of introduction of the clean synthesis gas into said at least one gas engine to produce electricity, so as to desaturate said clean synthesis gas of its humidity.

Advantageously, for a given pressure of the clean synthesis gas, the temperature of the purified and cleaned synthesis gas is lowered below the dew point of water, the water being evacuated by gravity, and said synthesis gas is then compressed, said compression raising the temperature of the synthesis gas.

A desaturated gas is thus obtained.

Advantageously, after compressing the synthesis gas, the gas thus compressed is cooled to a service temperature permitting its injection into said at least one engine and the acids, notably H₂S, contained in the synthesis gas thus compressed are removed before injection into said at least one gas engine.

Preferably, said synthesis gas is cooled to a temperature less than or equal to a maximum service temperature Ts=50° C. to feed said at least one gas engine.

said at least one gas engine is continuously fed with said clean synthesis gas, the pressure of the synthesis gas at the inlet of said at least one gas engine being constant or substantially constant.

Preferably, in step a), said solid recovered fuel SRF is supplied in an amount necessary to produce more synthesis gas than necessary for feeding said at least one engine in step f) and the fluctuations in volume of clean synthesis gas generated are regulated by producing, from the synthesis gas not injected into said at least one engine, steam to feed at least one steam turbine.

As a function of the fluctuations in volume of synthesis gas generated, a proportion of between at least 70% and 90% of the clean synthesis gas generated may thus be sent to said at least one gas engine.

Advantageously, at least one combustion chamber is fed with the surplus of said clean synthesis gas not injected into said at least one gas engine, the fumes derived from the combustion of said clean synthesis gas being sent to a water-fed heat-recovery unit which performs the heating of said water by recovering the heat from said fumes to produce steam.

Said at least one combustion chamber and said heat-recovery unit form an integral part of a combustion boiler.

in step d), the soot is recovered to be burnt in at least one combustion chamber, the fumes derived from the combustion of said soot being sent to a water-fed heat-recovery unit which performs the heating of said water by recovering the heat from said fumes to produce steam and to feed with said steam at least one steam turbine.

Thus, since the process of the disclosed embodiment generates a quantity of soot, said process is optimized in energy terms by recovering said soot, burning it and producing steam therefrom. Preferably, at least one combustion chamber of cyclone type is fed with said soot.

The extraction of the soot is advantageously performed with extraction means comprising an endless screw.

Advantageously, the level of soot at the outlet of the bag filter is controlled to ensure a suitable amount, i.e. between a minimum and a maximum, of soot feeding said at least one combustion chamber. For purely illustrative purposes, level sensors configured to determine these thresholds are used.

The soot is transported in a leaktight medium, preferably in a non-oxidizing medium, to said at least one combustion chamber in order to prevent its combustion during its transportation. By way of example, this soot is transported by a pneumatic conveyor.

According to another aspect of the process, water is transported to said recovery boiler(s) and the steam produced is transported to said at least one steam turbine in a closed circuit.

The presently disclosed embodiment also relates to a facility for performing the process for producing electricity as described previously, said facility comprising:

a gasification reactor for producing a raw synthesis gas,

a unit for purifying the raw synthesis gas, said unit comprising a mixing zone, in which said raw synthesis gas injected through at least one inlet port of said unit encounters and is mixed with at least one plasma jet and/or at least one oxidant stream, each plasma jet being generated by a plasma torch, preferably each oxidant stream being produced by a means for introducing an oxidant stream into said unit, said unit also comprising a reaction zone placed downstream of said mixing zone, in which takes place a reaction between said synthesis gas and said at least one plasma jet and/or said at least one oxidant stream in order to lower by thermal cracking the concentration of tars contained in the raw synthesis gas and to achieve a dew point of said tars of less than or equal to 20° C., the temperature of the synthesis gas at the outlet of said reaction zone being greater than or equal to 1100° C.,

a water-fed heat-recovery boiler configured to heat said water by recovering the heat from said synthesis gas to produce steam,

a filtration unit including at least one bag filter to clean the purified synthesis gas,

a washing/cooling device and a device for compressing the synthesis gas placed downstream of said washing/cooling device, in the direction of movement of said synthesis gas toward at least one gas engine, which make it possible to lower the degree of relative humidity of the clean synthesis gas generated at the outlet of the cleaning system,

at least one gas engine,

a combustion boiler to burn the surplus synthesis gas produced not sent to said at least one gas engine, said combustion boiler comprising at least one combustion chamber and at least one combustion gas outlet port connected to a heat-recovery unit, said heat-recovery unit being fed with water and being configured to heat said water by recovering the heat from said combustion gases to produce steam; and

at least one steam turbine fed with steam via at least said heat-recovery boiler and said heat-recovery unit to produce electricity, these elements together making it possible to maximize the energy efficiency of said facility.

According to one aspect of the facility of the disclosed embodiment, said at least one gas engine and said combustion boiler are placed in parallel so that the synthesis gas not sent to said at least one gas engine is sent to said boiler.

According to another aspect of the facility of the disclosed embodiment, said filtration unit includes in its lower part means for extracting said soot, which soot is sent to at least one combustion chamber of said boiler via a transportation means placed in a leaktight and non-oxidizing medium.

The soot derived from the thermal cracking of the tars in step c) is thus upgraded, since said tars have a very high heating value.

Preferably, these extraction means comprise an endless screw.

These extraction means may also comprise level sensors, notably a sensor determining a lower threshold level below which the amount of soot to be transported to feed the combustion boiler is insufficient.

According to another aspect of the facility of the disclosed embodiment, said combustion boiler includes at least one cyclone chamber to receive said soot.

According to another aspect of the facility of the disclosed embodiment, the circuit for conveying the water to said boilers and for transporting the steam to said at least one steam turbine is a closed-circuit transportation means.

### BRIEF DESCRIPTION OF THE DRAWINGS

Other particular advantages, aims and features of the presently disclosed embodiment, will emerge from the description which follows, given for the purposes of explanation and not being in any way limiting, with regard to the attached drawings, in which:

FIG. 1 schematically represents the steps of the process for producing electricity from an SRF feedstock according to a particular aspect of the presently disclosed embodiment;

FIG. 2 is a view in cross section of a bag filter of the electricity production facility according to one aspect of the presently disclosed embodiment of the present invention,

FIG. 3 schematically represents a combustion boiler of the facility of FIG. 2, said combustion boiler making it possible to upgrade the soot obtained from the bag filter and the excess clean synthesis gas generated by the process and not injected into the gas engines.

### DETAILED DESCRIPTION

First of all, it is noted that the figures are not to scale.

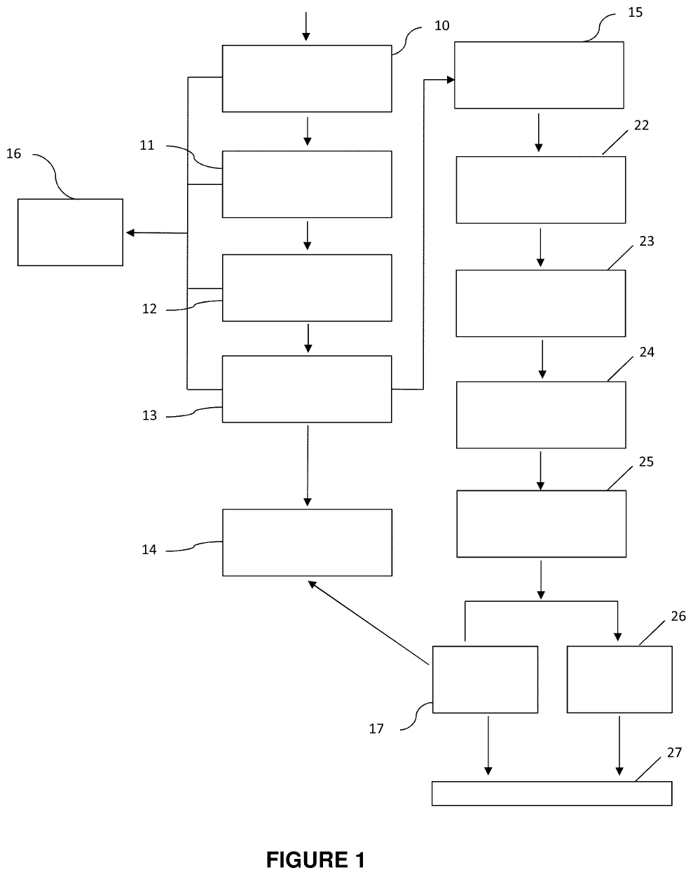

FIG. 1 schematically represents the various steps of the process for producing electricity from a solid recovered fuel (SRF) feedstock according to a particular aspect of the presently disclosed embodiment.

The identical elements appearing in the various figures bear the same reference numerals.

### Step 10 of Gasification of the Feedstock in a Fixed-Bed Gasifier

The feedstock to be treated is first introduced into a gasifier, at a known flow rate.

Thus, and preferably, the feedstock to be treated is injected into this gasifier via a cooled endless screw.

This feedstock to be treated is a solid recovered fuel (SRF) injected in ground form. The fuel is worked so as to feed the gasifier with a feedstock that is as homogeneous as possible. Such a feedstock also has the advantage of having a high lower heating value (LHV) but contains, on the other hand, pollutants such as chlorine.

The gasification consists in decomposing, in the presence of a reagent gas such as air, the ground SRF feedstock so as to obtain a crude, i.e. non-purified, gaseous product This synthesis gas, also referred to as the “product gas”, is advantageously rich in carbon monoxide (CO), dihydrogen (H₂), carbon dioxide (CO₂), methane (CH₄), water (H₂O) and nitrogen (N₂).

During this process, the feedstock to be treated is subjected to various thermochemical phenomena occurring successively:

pyrolysis, during which carbon-based matter undergoes thermal decomposition in the absence of oxygen and combustible and non-combustible gases are released by the feedstock. These gases thus comprise uncondensable vapors (methane, hydrogen, carbon monoxide, carbon dioxide, etc.) and tars.

combustion of the volatile matter derived from the pyrolysis step, leading to the production of carbon dioxide (CO₂) and water (H₂O), accompanied by evolution of heat,

gasification, which consists in reacting the char present in the feedstock to be treated with the carbon dioxide (CO₂) and the water vapor derived from the combustion step.

The combustion reactions are exothermic and provide the energy required for the gasification, which, itself, is endothermic.

The gasifier is advantageously equipped with an oxygen injection device ensuring enrichment of the gasification air so as to reduce the nitrogen content in the raw synthesis gas produced, and thus to limit its dilution.

For purely illustrative purposes, the oxygen content of the gasification air can thus be increased from 21% to 40%. In parallel, the nitrogen content in the gas then falls from 79% to 60%.

Since dilution of the gas with nitrogen is thus limited, the raw synthesis gas obtained at the gasifier outlet is richer. Advantageously, this addition of oxygen to the gasification air makes it possible to increase the LHV of the raw synthesis gas produced and also to increase the entering flow rate of the feedstock to be treated in the gasifier.

This gasifier is, here, a fixed-bed counter-current gasifier.

It is recalled that in such a gasifier, the feeding of the ground SRF feedstock takes place via the top of the reactor whereas the air is injected into the lower part of this reactor through a grate, which takes the form here of an openwork concrete sill.

This gasifier includes at least one stirrer, each stirrer including a mobile arm to spread out the feedstock on the openwork sill with a determined bed height so as to promote the gasification reactions over the entire bed.

The gasifier may also be equipped with a device for injecting vapor under the gasification bed. This injection of vapor, which gives rise to endothermic reactions, then makes it possible to limit the rise in temperature of the openwork sill to prevent vitrification of the ash, on account of the injection of enriched air.

The injection of this vapor advantageously has a twofold impact. It makes it possible not only to increase the content of CO and H₂ in the gas and, consequently, to increase the lower heating value (LHV) of the raw synthesis gas produced, but also to lower the carbon content in the ash recovered under the gasifier.

This residual ash not entrained in the gas is extracted from the gasifier and transported to a storage unit 16.

However, such a fixed-bed gasifier produces a large amount of tars, which it is worthwhile removing from the raw synthesis gas produced for the purpose of exploiting it.

The raw synthesis gas produced by the gasifier is thus directed toward a purification unit in order to undergo a “purification” step 12 during which the tars contained in this gas are notably removed.

Beforehand, and at the gasifier outlet, the raw synthesis gas is conveyed to a dust-removing device 11 which makes it possible to trap the dust contained in this gas and thus to have a raw synthesis gas that is less charged with solid particles.

### Purification Step 12

The purification unit receives the raw synthesis gas generated in the gasifier 10 and freed of dust by the dust-removing device 11 in order to carry out the removal of the tars present in large amount in this gas.

The purification unit comprises here, successively:

an introduction chamber to which is connected a reactor, the introduction chamber and the reactor each having an internal volume delimited by walls at least partially covered with refractory elements, this chamber and the reactor being in fluid communication,

the introduction chamber includes a non-transferred plasma arc torch having a main axis, this torch being intended to generate a plasma jet having an axis of propagation that is substantially colinear with the main axis of this torch,

the introduction chamber includes at least one inlet port placed downstream of this plasma torch for introducing the synthesis gas to be purified,

since the reactor has a substantially cylindrical elongated shape, the longitudinal axis of this reactor is substantially collinear with the axis of propagation of the plasma jet, the reactor including in its downstream part an outlet port for the purified synthesis gas,

the reactor comprises at its inlet an oxidizing ring, which includes a plurality of orifices for introducing an oxidant gas, such as air.

These introduction orifices are connected to a gas feed circuit, and are or are not uniformly distributed on the periphery of the reactor, thus defining an oxidizing ring.

This oxidizing ring makes it possible to send hot air into the purification unit so as to maintain high temperature levels throughout this unit and to create turbulence at the reactor head in order to optimize the mixing of the assembly formed by the synthesis gas, the plasma air and the oxidant gas, and thus to promote the thermal cracking reactions.

This hot air advantageously comes from a combustion boiler intended to burn the soot recovered from a bag filter during the cleaning of the purified synthesis gas and the excess clean synthesis gas not injected into the gas engines (see later).

This purification unit may be termed a system having a linear configuration, i.e. a plasma torch, then the injection device, then the reactor. Such a linear configuration has many advantages, notably great ease of operation, a suction effect of the synthesis gas and of the oxidant gas by the plasma jet, thereby ensuring intimate mixing of the synthesis gas, the plasma jet and the oxidant gas, but also entrainment of the synthesis gas/plasma jet/oxidant gas mixture along a straight line (the axis of propagation), which minimizes any interactions between this superheated mixture and the walls of the introduction chamber and of the reactor.

The intimate mixing thus achieved moreover ensures direct energy transfer, which not only allows reduced energy consumption, but also makes it possible to reach higher temperatures for the synthesis gas/plasma jet/oxidant gas mixture than with the devices of the prior art.

By means of the plasma jet, temperatures of the order of 3000° C. are reached locally, which are required for the cracking of tars. The synthesis gas thus purified has, at the outlet of the purification unit, a temperature typically of the order of 1200° C.

The reactions taking place in the reactor comprise thermal cracking, steam reforming and oxidation reactions. These reactions advantageously enrich the synthesis gas produced during the gasification step by transforming molecules into H₂ and CO.

These reactions also entail the formation of soot in the synthesis gas, which will be treated downstream of this purification unit.

These reactions make it possible to scrub out at least 90% of the tars contained in the raw synthesis gas.

The content of tars in the purified synthesis gas leaving the purification unit is in line with the specifications required for exploitation on gas engines (dew point below 20° C.).

The synthesis gas thus purified is sent to a treatment line before being sent to gas engines to generate electricity.

### Recovery Boiler

On leaving the purification unit, the purified synthesis gas is directed toward an energy recovery boiler 13 to cool this synthesis gas.

This recovery boiler 13 is composed of a radiation chamber with water tubes, and then of a series of exchangers of vaporizer/superheater and economizer type.

The role of this recovery boiler 13 is twofold here:

first, to ensure lowering of the temperature of the purified synthesis gas to a temperature which permits its treatment downstream of this boiler, and

second, to recover the heat from the purified synthesis gas in order to produce a maximum amount of steam which will serve to feed one or more steam turbines 14.

Thus, the temperature of the purified synthesis gas goes from 1200° C. at the inlet of said recovery boiler 13 to a temperature of about 200° C. The thermal energy of the purified synthesis gas is recovered here in the form of steam at 370° C. and 32 bar abs.

This recovery boiler 13 is also equipped with a line conveyor of Redler type for evacuating the residues. This part is a liquid seal which makes it possible to have a safety element on the boiler. It ensures perfect leaktightness of the process.

### Bag Filter

On leaving the recovery boiler 13, the purified and cooled synthesis gas is directed toward a bag filter 15 which makes it possible to collect all of the dust and solid particles contained in this gas.

The bag filter 15 is configured not only to capture the dust and other particles contained in the gas, but also to trap acids (SOx, HCl and HF).

The reagent used is slaked lime so as to allow neutralization of the chlorinated compounds contained in the synthesis gas.

The purified synthesis gas is sent to the bag filter 15 from the bottom upward, with capture of the particles on the filtering bags.

These filtering bags are cleaned periodically by counter-current injection of nitrogen.

Once clean, the purified synthesis gas is collected at the head of the bag filter 15 and directed toward a washing/cooling device.

Advantageously, the soot is also recovered in this bag filter 15 in order to be upgraded. To this end, the soot thus recovered is transported to feed a combustion boiler 17, the fumes derived from the combustion of said soot being sent to a water-fed heat-recovery unit which performs the heating of said water by recovering the heat from said fumes to produce steam and to feed with said steam at least one steam turbine 14.

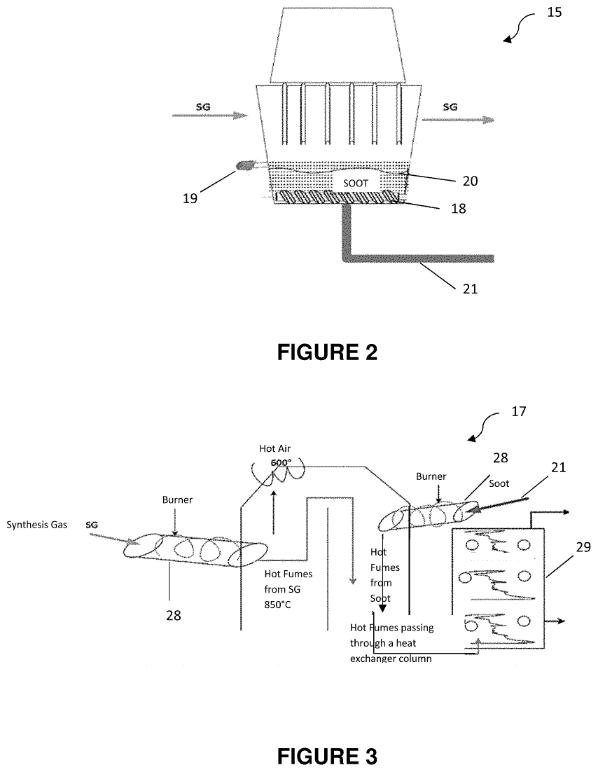

FIG. 2 is a schematic representation of this bag filter 15. The extraction of the soot is advantageously performed with extraction means comprising an endless screw 18. These extraction means also comprise one or more level sensors 19, in this case sensors placed on either side of a median line 20 to ensure that there is a sufficient amount of soot. By way of example, a first sensor determines a maximum threshold and a second sensor determines a minimum threshold not to be exceeded to ensure good dosing of the soot and also perfect leaktightness.

The soot thus extracted is transported in a medium free of air to avoid its combustion. This soot is transported here by a pneumatic conveyor 21.

### Quench

The synthesis gas freed of its ash and particles is subjected to a quenching step 22 or quench, in a washing/cooling device, which cools it from a temperature at the inlet of the device of the order of 200° C. to a temperature at the outlet of the device of about 40° C.

This lowering of the temperature of the synthesis gas is first obtained by means of the evaporation of an aqueous solution sprayed in a saturation chamber, which makes it possible to lower the temperature of the synthesis gas to about 70° C. It is then washed by circulating counter-currentwise a stream of drops of washing solution falling as rain, which make it possible to capture the residual tars and dust.

The synthesis gas then enters structured packing beds where it is further cooled to a temperature of the order of 40° C. by means of a cooling solution trickling over the packing, the solution circulating in a closed circuit. A deconcentrating purge containing the compounds absorbed by the washing solution is sent to a station for treating the process waters.

The totally clean and cooled synthesis gas is then directed toward a booster compressor 23.

### Booster Compressor 23

At the outlet of the washing/cooling device, the clean synthesis gas is sent to a booster compressor 23. This device is configured to accept a synthesis gas at negative pressure upstream thereof and to compress this synthesis gas so as to convey it to gas engines and a combustion boiler 17, while at the same time limiting any risks of leakage. Typically, the synthesis gas leaves the booster compressor with a pressure of the order of a hundred millibar at the inlet of the engines 26.

The booster compressor thus makes it possible to compensate for the various pressure losses in the line, and to ensure a pressure at the inlet of the gas engines 26 which meets the service specifications. Compression of the synthesis gas by the booster compressor 23 entails a slight increase in its temperature, this temperature being here of the order of 60° C.

### Cooling System

At the outlet of the booster compressor 23, the gas is sent to a cooling system 24, such as a heat exchanger. The purpose of this system is to lower the temperature of the clean synthesis gas to a service temperature that is admissible for the gas engines 26. This maximum service temperature is, here, 50° C.

### H₂S Scrubbing System

After cooling, the clean synthesis gas is sent to a system 25 for scrubbing out the sulfur derivatives. A chemical adsorption reaction makes it possible to trap the sulfur derivatives contained in the clean synthesis gas.

To this end, a portion of the clean synthesis gas is sent through a bed of active charcoal composed of particles with a mean diameter of the order of several millimeters.

A chemical reaction takes place between the H₂S contained in the synthesis gas (SG) and the active charcoal, allowing the sulfur to be taken up. In order for the adsorption to be optimal, the temperature of the synthesis gas must be about 50° C.

Such a reaction has the advantage of not requiring fuel oil and also of not oxidizing the synthesis gas.

### Combustion Boiler 17

The combustion boiler 17 is positioned at the outlet of the H₂S scrubbing system 25, placed in parallel with the gas engines 26. This boiler 17 is equipped with a burner allowing the combustion of the surplus synthesis gas not injected into the gas engines 26.

This combustion boiler has several missions:
to regulate the pressure of the gas at the inlet of the gas engines,
to ensure flexibility on the piloting of these engines. Specifically, said boiler is dimensioned to accept between 10% and 30% of the total output of the synthesis gas produced,
burning the synthesis gas (SG) not sent to the engines and also the soot recovered by the bag filter, before discharging into the atmosphere so that the chimney 27 complies with the regulations in force, and
producing steam which will be sent to a steam turbine 14 to produce electricity.

FIG. 3 is a schematic representation of this combustion boiler 17. The combustion of the soot and of the excess clean synthesis gas produced by the process of the disclosed embodiment is performed in cyclone chambers 28 integrated into this combustion boiler 17. Said boiler also comprises a combustion gas outlet port connected to a heat-recovery unit 29, this heat-recovery unit being fed with water and being configured to heat this water by recovering the heat from the combustion gases to produce steam.

### Water-Steam Network

Recovery of heat is advantageously envisaged in the facility for performing the electricity production process in order to maximize the overall energy efficiency of the process.

After the purification unit, the synthesis gas is thus advantageously sent to an energy recovery boiler 13 which makes it possible to produce high-pressure steam.

To do this, the heat-recovery boiler is fed with water and is configured to heat this water by recovering the heat from the purified synthesis gas in order to produce steam.

Finally, a combustion boiler 17 is installed in parallel with the gas engines in order to treat the surplus clean synthesis gas not sent to the gas engines. As described above, this combustion boiler 17 also produces steam.

The electricity production facility thus includes a steam supply network which is a closed-loop network, which comprises the following elements:

a heat-recovery boiler: The recovery boiler, located outside, cools the purified synthesis gas coming from the purification unit and produces superheated steam under the same pressure and temperature conditions as the combustion boiler 17.

a combustion boiler 17, which has been described above,

a high-pressure barrel, which forms the collector of the steam produced by the various boilers.

This has several roles and notably:

under nominal functioning: all of the steam generated is sent to the turbine admission.

under degraded functioning, for example in the event of a problem on the turbine or regarding the steam quality, the steam is sent to a hydrocondenser via a bypass.

steam is also withdrawn from the barrel to feed the vacuum group of the hydrocondenser. A portion of the steam produced may also be used to feed the thermal degasser in transitional periods.

a steam turbine: under normal running, the steam generated in the facility is sent to the turbine which is coupled to an electricity production generator.

The low-pressure steam coming from the turbine is then condensed via a hydrocondenser under vacuum.

extraction pumps: On leaving the hydrocondenser, the condensates are extracted with extraction pumps. Their role is to remove the condensates from the hydrocondenser to send them to a feed tank.

a feed tank and a thermal degasser: The feed tank has the role of feeding with water the boilers, with a water of optimum quality, and more particularly a water with a very low oxygen content. The water temperature is about 105° C. heated by the barrel drawdown or turbine drawdown, in order to remove the oxygen contained in the water.

feed pumps: Three feed pumps are installed, two for the functioning, the last being positioned as a backup for the other two, in order to ensure the continuous feeding of water to the boiler.

The water-steam network is a closed circuit which makes it possible to recover all the steam produced in said facility by the process and to reinject it into the electricity production facility.

As an example of implementation, the various items of equipment of the facility, whether it be the turbine via the hydrocondenser, or the heat recovery on the engines, make it possible to upgrade an amount of heat of the order of 17 MW thermal.

1. A process for producing electricity, comprising the following successive steps:
a) providing a solid recovered fuel;
b) producing a raw synthesis gas from the solid recovered fuel;
c) purifying said raw synthesis gas to generate a synthesis gas whose reduced concentration of tars determines a dew point of said tars of less than or equal to 20° C., said purification step comprising the injection of said raw synthesis gas into a mixing zone, in which said raw synthesis gas encounters and is mixed with at least one plasma jet and/or at least one oxidant stream, and initiation of a reaction between said synthesis gas and said at least one plasma jet and/or said at least one oxidant stream in a reaction zone placed downstream of said mixing zone to thermally crack the tars, the temperature of the synthesis gas at the outlet of said reaction zone being greater than or equal to 1100° C.;
d) cleaning said synthesis gas thus purified to obtain a clean synthesis gas;
e) lowering the relative degree of humidity of the clean synthesis gas;
f) injecting at least a portion thereof into at least one gas engine to produce electricity.

2. The process as claimed in claim 1, wherein after step c) and before step d), the purified synthesis gas is cooled in a water-fed heat-recovery boiler which performs the heating of said water by recovering the heat from said synthesis gas to produce steam and to feed with said steam at least one steam turbine.

3. The process as claimed in claim 1, wherein in step e), the clean synthesis gas is cooled to a temperature below a temperature of introduction of the clean synthesis gas into said at least one gas engine to produce electricity, so as to desaturate said clean synthesis gas of its humidity.

4. The process as claimed in claim 3, wherein after compressing the synthesis gas, the gas thus compressed is cooled to a service temperature permitting its injection into said at least one engine and the acids contained in the synthesis gas thus compressed are removed before injection into said at least one gas engine.

5. The process as claimed in claim 1, wherein said at least one gas engine is continuously fed with said clean synthesis gas, the pressure of the synthesis gas at the inlet of said at least one gas engine being constant or substantially constant.

6. The process as claimed in claim 5, wherein in step a), said solid recovered fuel is supplied in an amount necessary to produce more synthesis gas than necessary for feeding said at least one engine in step f) and in that the fluctuations in volume of clean synthesis gas generated are regulated by producing, from the synthesis gas not injected into said at least one engine, steam to feed at least one steam turbine.

7. The process as claimed in claim 6, wherein at least one combustion chamber is fed with the surplus of said clean synthesis gas not injected into said at least one gas engine, the fumes derived from the combustion of said clean synthesis gas being sent to a water-fed heat-recovery unit which performs the heating of said water by recovering the heat from said fumes to produce steam.

8. The process as claimed in claim 1, wherein in step d), the soot is recovered to be burnt in at least one combustion chamber, the fumes derived from the combustion of said soot being sent to a water-fed heat-recovery unit which performs the heating of said water by recovering the heat from said fumes to produce steam and to feed with said steam at least one steam turbine.

9. The process as claimed in claim 8, wherein said soot is extracted by means of extraction means, and said soot is then transported in a leaktight and non-oxidizing medium to said at least one combustion chamber.

10. A facility for performing the electricity production process as claimed in claim 1, said facility comprising:
a gasification reactor for producing a raw synthesis gas;
a unit for purifying the raw synthesis gas, said unit comprising a mixing zone, in which said raw synthesis gas injected through at least one inlet port encounters and is mixed with at least one plasma jet and/or at least one oxidant stream, each plasma jet being generated by a plasma torch, said unit also comprising a reaction zone placed downstream of said mixing zone, in which takes place a reaction between said synthesis gas and said at least one plasma jet and/or said at least one oxidant stream in order to lower by thermal cracking the concentration of tars contained in the raw synthesis gas and to achieve a dew point of said tars of less than or equal to 20° C., the temperature of the synthesis gas at the outlet of said reaction zone being greater than or equal to 1100° C.;
a water-fed heat-recovery boiler configured to heat said water by recovering the heat from said purified synthesis gas to produce steam;
a filtration unit including at least one bag filter to clean the purified synthesis gas;
a washing/cooling device and a device for compressing the synthesis gas placed downstream of said washing/cooling device, in the direction of movement of said synthesis gas toward at least one gas engine;
at least one gas engine;
a combustion boiler to burn the surplus synthesis gas produced not sent to said at least one gas engine, said combustion boiler comprising at least one combustion chamber and at least one combustion gas outlet port connected to a heat-recovery unit, said heat-recovery unit being fed with water and being configured to heat said water by recovering the heat from said combustion gases to produce steam; and
at least one steam turbine fed with steam via at least said heat-recovery boiler and said heat-recovery unit to produce electricity, these elements together making it possible to maximize the energy efficiency of said facility.

11. The facility as claimed in claim 10, wherein said at least one gas engine and said boiler are placed in parallel so that the synthesis gas not sent to said at least one gas engine is sent to said boiler.

12. The facility as claimed in claim 10, wherein said filtration unit includes in its lower part means for extracting said soot, which soot is sent to at least one combustion chamber of said boiler via a transportation means placed in a leaktight medium.

13. The facility as claimed in claim 10, wherein said combustion boiler includes at least one cyclone chamber to receive said soot.
